(19) United States
(12) Patent Application Publication
(10) Pub. No.: US 2026/0292945 A1
(43) Pub. Date: Sep. 24, 2026

(54) COOKING APPLIANCE, CONTROL METHOD AND DEVICE THEREOF, ELECTRONIC DEVICE AND COMPUTER-READABLE STORAGE MEDIUM

(71) Applicant: GUANGDONG MIDEA KITCHEN APPLIANCES MANUFACTURING CO., LTD., FOSHAN (CN)

(72) Inventors: Liang LI, FOSHAN (CN); Bangqiang HAN, FOSHAN (CN); Zhifei ZHU, FOSHAN (CN)

(21) Appl. No.: 19/086,061

(22) Filed: Mar. 20, 2025

(30) Foreign Application Priority Data
Feb. 4, 2024 (CN) 202410162135.1

(51) Int. Cl. H05B 6/64; A23L 5/10; A47J 36/16; A47J 36/32; A47J 37/06; F24C 15/00; F24C 15/32; H05B 6/68

(52) U.S. Cl. CPC H05B 6/6473; A23L 5/15; A23L 5/17; A47J 36/16; A47J 36/32; A47J 37/0641; F24C 15/007; F24C 15/322; H05B 6/687

(57) ABSTRACT

The present application provides a cooking appliance and a control method and a device thereof, an electronic device and a computer-readable storage medium, relates to the field of household appliances, and the cooking appliance includes a cooking cavity and a heating part, the heating part is configured for supplying heat to the cooking cavity, and the control method includes the following steps: receiving an operation input of the cooking appliance; in response to the operation input, acquiring a temperature value of the cooking cavity and controlling the cooking appliance to enter a heating mode corresponding to the operation input; and the heating mode includes a first mode and a second mode, and in the case that the heating mode is the first mode, the heating part is controlled to operate with a first temperature rise parameter; and under the second mode.

### CROSS-REFERENCE TO RELATED APPLICATION

This application claims priority to Chinese Patent Application No. 202410162135.1, filed with the China National Intellectual Property Administration on Feb. 4, 2024, the entire contents of which are hereby incorporated by reference.

### FIELD

The present application relates to the field of household appliances, and particularly relates to a cooking appliance, a control method and a device thereof, an electronic device and a computer-readable storage medium.

### BACKGROUND

At present, cooking appliances have become essential kitchen appliances for most families. People use cooking appliances to cook various dishes on their own. However, a cooking appliance in related art can only cook food ingredients in a single heating mode, for example, it can only supply heat to a cooking cavity through a fixed temperature value, and cannot adapt to the different temperature rise curves required by different food ingredients.

### SUMMARY

The present application aims to solve at least one of the problems in the prior art or related art.

Therefore, the first aspect of the present application provides a control method for a cooking appliance.

The second aspect of the present application further provides a control device of a cooking appliance.

The third aspect of the present application further provides a cooking appliance.

The fourth aspect of the present application further provides an electronic device.

The fifth aspect of the present application further provides a computer-readable storage medium.

In view of this, the first aspect of the present application provides a control method for a cooking appliance, the cooking appliance includes a cooking cavity and a heating part, the heating part is configured for supplying heat to the cooking cavity, and the control method includes: receiving an operation input for the cooking appliance; in response to the operation input, acquiring a temperature value of the cooking cavity and controlling the cooking appliance to enter a heating mode corresponding to the operation input; and the heating mode includes a first mode and a second mode, and in the case that the heating mode is the first mode, the heating part is controlled to operate with a first temperature rise parameter; and under the second mode, the heating part is controlled to operate with a second temperature rise parameter, and the first temperature rise parameter is different from the second temperature rise parameter.

The control method for a cooking appliance provided by the present application includes: receiving the operation input for the cooking appliance; in response to the operation input, acquiring the temperature value of the cooking cavity and controlling the cooking appliance to enter a heating mode corresponding to the operation input. Specifically, the heating mode includes a first mode and a second mode, and in the case that the heating mode is the first mode, the heating part is controlled to operate with a first temperature rise parameter; and in the case that the heating mode is the second mode, the heating part is controlled to operate with a second temperature rise parameter. That is, the cooking appliance has at least two types of heating modes, and the first temperature rise parameter under the first mode is different from the second temperature rise parameter under the second mode, and therefore, the cooking appliance can achieve cooking different food ingredients through two different heating modes, and different food ingredients can be cooked through different temperature rise parameters, and this improves the cooking effect of different food ingredients, further enables the control method for the cooking appliance provided in the present application to adapt to the cooking of various food ingredients, and therefore, different food ingredients have different temperature rise curves, and users can choose a heating mode suitable for the food ingredients when cooking to achieve a desired cooking effect.

In a specific application, the first mode is a coloring mode, that is, when the food ingredients are cooked through the first temperature rise parameter, the food ingredients can be colored better. The second mode is a stable mode; when the food ingredients are cooked through the second temperature rise parameter, it can prevent the food ingredients from being burnt, and allow the food ingredients to be cooked stably and thoroughly.

Optionally, the first temperature rise parameter includes a heating temperature and a heating duration. The second temperature rise parameter includes a heating temperature and a heating duration, and a first heating curve formed by the first temperature rise parameter is different from a second heating curve formed by the second temperature rise parameter due to different heating temperatures and heating durations.

Based on the control method for a cooking appliance provided by the present application, it may further include the following additional features.

In some embodiments, the first temperature rise parameter includes a first target temperature value; in the case that the heating mode is the first mode, the step of controlling the heating part to operate with the first temperature rise parameter includes: acquiring the first target temperature value; determining the first temperature value and the second temperature value based on the first target temperature value; controlling the temperature value of the cooking cavity to fluctuate back and forth between the first temperature value and the second temperature value; and the second temperature value is greater than the first target temperature value, and the first target temperature value is greater than the first temperature value.

In some embodiments, the first temperature rise parameter includes the first target temperature value, and the step of controlling the heating part to operate with the first temperature rise parameter includes: acquiring the first target temperature value, determining the first temperature value and the second temperature value based on the first target temperature value, and controlling the heating part to supply heat to the cooking cavity, and the temperature value inside the cooking cavity fluctuates back and forth between the first temperature value and the second temperature value, then the curve formed by the temperature value inside the cooking cavity and the heating duration is a temperature curve with a peak and a valley, and then the food ingredients can be cooked through the back and forth fluctuating temperature, and this heating method is more conducive to the coloring of the food ingredients, and further achieves a better color of the cooked food and enhances the cooking effect.

In some embodiments, the step of controlling the temperature value of a cooking cavity to fluctuate back and forth between the first temperature value and the second temperature value includes: in the case that the temperature value of the cooking cavity is less than or equal to the first temperature value, controlling the heating part to increase its power; in the case that the temperature value of the cooking cavity is greater than or equal to the second temperature value, controlling the heating part to reduce its power or turn it off.

In one embodiment, the step of controlling the temperature value of the cooking cavity to fluctuate back and forth between the first temperature value and the second temperature value includes: in the case that the temperature value of the cooking cavity is less than or equal to the first temperature value, increasing the power of the heating part, and the temperature value inside the cooking cavity gradually increases until it reaches the second temperature value; in the case that the temperature value of the cooking cavity is greater than or equal to the second temperature value, reducing the power of the heating part, and the temperature value inside the cooking cavity gradually reduces until it reaches the first temperature value, and fluctuates back and forth in this way; and in the case that the temperature value inside the cooking cavity is greater than or equal to the second temperature value, the heating part can be directly turned off to quickly lower the temperature value inside the cooking cavity, and thereby, the coloring effect of the food ingredients is improved.

In some embodiments, the first temperature value is equal to the difference between the first target temperature value and a temperature threshold, and the second temperature value is equal to the sum of the first target temperature value and the temperature threshold.

In some embodiments, the first temperature value is equal to the difference between the first target temperature value and the temperature threshold, and the second temperature value is equal to the sum of the first target temperature value and the temperature threshold; furthermore, the first temperature value and the second temperature value can be determined based on the first target temperature value and the temperature threshold, to control the heating part to supply heat to the cooking cavity under the first mode, and the temperature value inside the cooking cavity fluctuates between the first temperature value and the second temperature value.

In some embodiments, the temperature threshold is greater than or equal to 3℃ and less than or equal to 15℃.

In some embodiments, the temperature threshold is greater than or equal to 3℃ and less than or equal to 15℃, and the temperature value inside the cooking cavity fluctuates in a large range, and then the coloring effect under the first mode is improved.

In some embodiments, the first mode includes a temperature rise stage and a constant temperature stage, and the step of controlling the temperature value of the cooking cavity to fluctuate back and forth between the first temperature value and the second temperature value includes: in the constant temperature stage, controlling the temperature value of the cooking cavity to fluctuate back and forth between the first temperature value and the second temperature value.

In some embodiments, the first mode includes a temperature rise stage and a constant temperature stage, and after the heating part is turned on, the temperature value inside the cooking cavity gradually increases, and this causes the temperature rise curve inside the cooking cavity to enter the constant temperature stage from the temperature rise stage. In the constant temperature stage, controlling the temperature value of the cooking cavity to fluctuate between the first temperature value and the second temperature value can not only achieve rapid cooking of the food ingredients, but further ensure the coloring effect of the food ingredients.

In some embodiments, the second temperature rise parameter includes a second target temperature value. Under the second mode, the step of controlling the heating part to operate with the second temperature rise parameter includes: acquiring the second target temperature value; controlling the temperature value of the cooking cavity to increase to the second target temperature value.

In some embodiments, the second temperature rise parameter includes the second target temperature value. Under the second mode, the step of controlling the heating part to operate with the second temperature rise parameter specifically includes: acquiring the second target temperature value; controlling the heating part to operate, and the temperature value inside the cooking cavity increases to the second target temperature value, thereby achieving supplying heat stably to the food ingredients inside the cooking cavity.

In some embodiments, the number of the heating parts is at least two, and the cooking appliance further includes a cavity partition plate, and the cavity partition plate is detachably connected to the cooking cavity. In the case that the cavity partition plate is arranged in the cooking cavity, it divides the cooking cavity into at least two cavity bodies. The cooking appliance enters an independent temperature control mode, at least two heating parts supply heat to the at least two cavity bodies respectively, and the technical solution further includes: acquiring the temperature control mode of the cooking appliance; in the case that the temperature control mode is the independent temperature control mode, receiving operation inputs corresponding to the at least two cavity bodies respectively; in response to the operation inputs corresponding to the at least two cavity bodies, acquiring the temperature values of the at least two cavity bodies and controlling the at least two cavity bodies to enter heating modes corresponding to the operation inputs.

In some embodiments, the number of the heating parts is at least two, and the cooking appliance further includes the cavity partition plate, and the cavity partition plate is detachably connected to the cooking cavity. In the case that the cavity partition plate is arranged in the cooking cavity, it divides the cooking cavity into at least two cavity bodies. The cooking appliance enters the independent temperature control mode, the at least two heating parts achieve the heating of the at least two cavity bodies respectively, and furthermore, cooking different food ingredients is achieved through the at least two cavity bodies, and then the cooking efficiency is improved; in the case that the cavity partition plate is separated from the cooking cavity, the volume of the cooking cavity is relatively large, and this enables the cooking of food ingredients with a relatively large volume; at the same time, at least two heating parts can be configured to cook one type of food ingredient simultaneously, and this improves the cooking efficiency. The control method for a cooking appliance further includes: acquiring the temperature control mode of the cooking appliance; in the case that the temperature control mode of the cooking appliance is independent temperature control, it means that the cavity partition plate has been inserted into the cooking cavity, the cooking cavity is divided into at least two cavity bodies, and in this situation, receiving operation inputs corresponding to the at least two cavity bodies respectively; after responding to the operation inputs corresponding to the at least two cavity bodies, acquiring the temperature values of the at least two cavity bodies respectively, and allowing the at least two cavity bodies to enter the corresponding heating modes respectively, and the at least two cavity bodies can realize the heating mode under the first mode and the second mode respectively, that is, under the mode of independent temperature control of the cooking appliance, different heating modes can be realized through the at least two cavity bodies, for example, one cavity body can realize the heating of the first mode, and the food ingredients can be better colored, and the other cavity body can realize the heating of the second mode, and the food ingredients can be cooked stably and thoroughly.

In some embodiments, the cooking appliance further includes a switch, and the switch is provided inside the cooking cavity. In the case that the cavity partition plate is provided inside the cooking cavity, the cavity partition plate can trigger the switch; the step of acquiring the temperature control mode of the cooking appliance includes: acquiring the trigger information of the switch; in the case that the switch is triggered, determining that the cooking appliance enters the independent temperature control mode.

In some embodiments, the cooking appliance further includes the switch, and the switch is provided inside the cooking cavity. In the case that the cavity partition plate is provided inside the cooking cavity, the cavity partition plate can trigger the switch, and then the cooking appliance enters the independent temperature control mode. Specifically, the trigger information of the switch is obtained, upon receiving that the switch has been triggered, it is determined that the cooking appliance enters the independent temperature control mode; under the independent temperature control mode, the control of the heating parts corresponding to the at least two cavity bodies can be realized respectively, thereby causing the heating parts corresponding to the at least two cavities to realize either the first mode or the second mode.

Based on the second aspect of the present application, a control device of a cooking appliance is further provided, and the cooking appliance includes a cooking cavity and a heating part, the heating part is configured to supply heat to the cooking cavity, and the control device of a cooking appliance includes: a receiving unit, configured for receiving an operation input for the cooking appliance; a response unit, configured for responding to the operation input; a control unit configured for acquiring the temperature value of the cooking cavity and controlling the cooking appliance to enter a heating mode corresponding to the operation input; and the heating mode includes a first mode and a second mode; in the case that the heating mode is the first mode, the heating part is controlled to operate with a first temperature rise parameter; under the second mode, the heating part is controlled to operate with a second temperature rise parameter, and the first temperature rise parameter is different from the second temperature rise parameter.

The control device of a cooking appliance provided by the second aspect of the present application includes the receiving unit, the response unit and the control unit; the receiving unit is configured for receiving an operation input for the cooking appliance; the response unit responds to the operation input; the control unit is configured for acquiring the temperature value of the cooking cavity and controlling the cooking appliance to enter the heating mode corresponding to the operation input. Specifically, the heating mode includes the first mode and the second mode; in the case that the heating mode is the first mode, the control unit controls the heating part to operate with the first temperature rise parameter; in the case that the heating mode is the second mode, the control unit controls the heating part to operate with the second temperature rise parameter, that is, the cooking appliance has at least two heating modes, and the first temperature rise parameter under the first mode is different from the second temperature rise parameter under the second mode, and the cooking appliance can cook different food ingredients through two different heating modes, and thus different food ingredients can be cooked through different temperature rise parameters, and this improves the cooking effects of different food ingredients, and further enables the control method for a cooking appliance provided in the present application to adapt to the cooking of various food ingredients, as a result, different food ingredients have different temperature rise curves, and then, users can choose the heating modes suitable for the food ingredients when cooking to achieve desired cooking effects.

The third aspect of the present application further provides a cooking appliance, including: a cooking cavity; a heating part, and the heating part is configured to supply heat to the cooking cavity; and the control device of a cooking appliance provided in any of the second aspect.

The cooking appliance provided by the third aspect of the present application includes the cooking cavity and the heating part configured to supply heat to the cooking cavity. The control device receives the operation input for the cooking appliance, and in response to the operation input, acquires the temperature value of the cooking cavity and controls the cooking appliance to enter the heating mode corresponding to the operation input. Specifically, the heating mode includes the first mode and the second mode. In the case that the heating mode is the first mode, the heating part is controlled to operate with the first temperature rise parameter. In the case that the heating mode is the second mode, the heating part is controlled to operate with the second temperature rise parameter, that is, the cooking appliance has at least two heating modes, and the first temperature rise parameter under the first mode is different from the second temperature rise parameter under the second mode, and the cooking appliance can cook different food ingredients through two different heating modes, and thus different food ingredients can be cooked through different temperature rise parameters, and this improves the cooking effects of different food ingredients, and further enables the control method for a cooking appliance provided in the present application to adapt to the cooking of various food ingredients, as a result, different food ingredients have different temperature rise curves, and then, users can choose the heating modes suitable for the food ingredients when cooking to achieve desired cooking effects.

In some embodiments, the number of the heating parts is at least two, and the cooking appliance further includes a cavity partition plate, and the cavity partition plate is detachably connected to the cooking cavity. In the case that the cavity partition plate is arranged in the cooking cavity, it divides the cooking cavity into at least two cavity bodies. The cooking appliance enters an independent temperature control mode, and at least two heating parts supply heat to the at least two cavity bodies respectively.

In some embodiments, the number of the heating parts is at least two, and the cooking appliance further includes the cavity partition plate, and the cavity partition plate is detachably connected to the cooking cavity. In the case that the cavity partition plate is arranged in the cooking cavity, it divides the cooking cavity into at least two cavity bodies. The cooking appliance enters the independent temperature control mode, the at least two heating parts achieve supplying heat to the at least two cavity bodies respectively, and furthermore, cooking different food ingredients is achieved through the at least two cavity bodies, and then the cooking efficiency is improved; in the case that the cavity partition plate is separated from the cooking cavity, the volume of the cooking cavity is relatively large, and this enables the cooking of food ingredients with a relatively large volume; at the same time, at least two heating parts can be configured to cook one type of food ingredient simultaneously, and this improves the cooking efficiency.

In some embodiments, the cooking appliance further includes a switch, and the switch is provided inside the cooking cavity. In the case that the cavity partition plate is provided inside the cooking cavity, the cavity partition plate can trigger the switch.

In some embodiments, the cooking appliance further includes the switch, and the switch is provided inside the cooking cavity. In the case that the cavity partition plate is provided inside the cooking cavity, the cavity partition plate can trigger the switch, and then the cooking appliance enters the independent temperature control mode.

In some embodiments, the cooking appliance further includes: a baking tray, detachably provided inside the cooking cavity; and/or at least two cavity bodies being distributed vertically.

In some embodiments, the at least two cavity bodies are distributed vertically, and this reduces the occupation of the horizontal space of the kitchen by the cooking appliance and facilitates the storage of the cooking appliance. The cooking appliance further includes the baking tray, and the baking tray can carry the food ingredients and further achieve the cooking of the food ingredients.

In some embodiments, the heating part includes a hot air assembly, and the hot air assembly is configured to deliver hot air into the cooking cavity.

In some embodiments, the heating part includes the hot air assembly, and the hot air assembly can deliver hot air into the cooking cavity, and this further achieves air frying of the food ingredients.

In some embodiments, the heating part includes a heating tube for radiating heat into the cooking cavity. That is, the heating part in the present application can be a heating tube, and in the case that there are at least two heating tubes, the at least two heating parts respectively radiate heat into the cooking cavity.

In some embodiments, the heating part further includes a microwave generating part for feeding microwaves into the cooking cavity.

In some embodiments, the heating part further includes the microwave generating part for feeding microwaves into the cooking cavity, and this further achieves microwave cooking of the food ingredients inside the cooking cavity.

The fourth aspect of the present application further provides an electronic device, including: a processor and a memory, and the memory stores programs or instructions which can be executed on the processor, when the programs or instructions are executed by the processor, the steps of the control method for a cooking appliance provided in any of the first aspect are achieved. Therefore, the electronic device has all the beneficial effects of the control method for a cooking appliance, which will not be repeated here.

The fifth aspect of the present application provides a computer-readable storage medium, in which programs or instructions are stored, when the programs or instructions are executed by the processor, the steps of the control method for a cooking appliance provided in any of the first aspect are implemented. Therefore, the computer-readable storage medium has all the beneficial effects of the control method for a cooking appliance, which will not be repeated here.

The additional embodiments of the present application will be disclosed in the following description, or learned through practice of the present application.

### BRIEF DESCRIPTION OF THE DRAWINGS

The above and/or additional embodiments of the present application will become apparent and easily understood from the description of the embodiments in combination with the following figures:

FIG. 1 is a first flow chart of a control method for a cooking appliance in an embodiment of the present application;

FIG. 2 is a second flow chart of a control method for a cooking appliance in an embodiment of the present application;

FIG. 3 is a third flow chart of a control method for a cooking appliance in an embodiment of the present application;

FIG. 4 is a diagram of the temperature rise curve of a cooking appliance under a first mode and under a second mode in an embodiment of the present application;

FIG. 5 is a schematic view of the structure of a cooking appliance in an embodiment of the present application;

FIG. 6 is a schematic block diagram of a heating part in an embodiment of the present application;

FIG. 7 is a schematic block diagram of a cooking appliance in an embodiment of the present application;

FIG. 8 is a schematic block diagram of a control device of a cooking appliance in an embodiment of the present application;

FIG. 9 is an interactive logic diagram of a cooking appliance in an embodiment of the present application; and

FIG. 10 is a schematic block diagram of an electronic device in an embodiment of the present application.

The corresponding relationships between the reference signs and the component names in FIGS. 5 to 7 are as follows:

1 cooking cavity, 10 cavity body, 2 switch, 3 cavity partition plate, 4 heating part, 40 hot air assembly, 42 microwave generating part, 5 control device, 6 baking tray, 7 cooking appliance.

### DETAILED DESCRIPTION OF THE DISCLOSURE

To more clearly understand the embodiments of the present application, the present application will be further detailed hereinafter in combination with the accompanying drawings and embodiments. It should be indicated that the embodiments and the features in the embodiments can be combined with each other in the case of no conflict.

Many details are illustrated in the following description for the convenience of a thorough understanding of the present application, but the present application can further be implemented using other embodiments other than these described herein. Therefore, the protection scope of the present application is not limited to the specific embodiments disclosed in the following text.

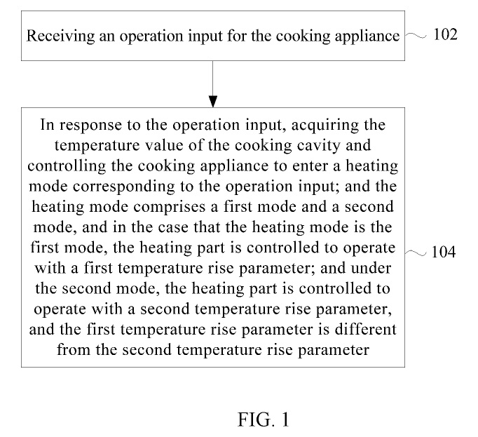

A control method for a cooking appliance, a control device of a cooking appliance, a cooking appliance, an electronic device and a computer-readable storage medium provided in some embodiments of the present application are described in the following text referring to FIGS. 1 to 10.

Based on an embodiment of the present application, the present application provides a control method for a cooking appliance, configured for a cooking appliance, the cooking appliance includes a cooking cavity and a heating part, and the heating part is configured for supplying heat to the cooking cavity.

As shown in FIG. 1, it shows a flow chart of a control method for a cooking appliance.

Step 102: receiving an operation input for the cooking appliance;

Step 104: in response to the operation input, acquiring a temperature value of the cooking cavity and controlling the cooking appliance to enter a heating mode corresponding to the operation input; and the heating mode includes a first mode and a second mode, and in the case that the heating mode is the first mode, the heating part is controlled to operate with a first temperature rise parameter; and under the second mode, the heating part is controlled to operate with a second temperature rise parameter, and the first temperature rise parameter is different from the second temperature rise parameter.

The control method for a cooking appliance provided by the present application includes: receiving the operation input for the cooking appliance; in response to the operation input, acquiring the temperature value of the cooking cavity and controlling the cooking appliance to enter a heating mode corresponding to the operation input. Specifically, the heating mode includes a first mode and a second mode, and in the case that the heating mode is the first mode, the heating part is controlled to operate with a first temperature rise parameter; and in the case that the heating mode is the second mode, the heating part is controlled to operate with a second temperature rise parameter. That is, the cooking appliance has at least two types of heating modes, and the first temperature rise parameter under the first mode is different from the second temperature rise parameter under the second mode, and therefore, the cooking appliance can achieve cooking different food ingredients through two different heating modes, and different food ingredients can be cooked through different temperature rise parameters, and this improves the cooking effect of different food ingredients, further enables the control method for the cooking appliance provided in the present application to adapt to the cooking of various food ingredients, and therefore, different food ingredients have different temperature rise curves, and users can choose a heating mode suitable for the food ingredients when cooking to achieve a desired cooking effect.

In a specific application, the first mode is a coloring mode, that is, when the food ingredients are cooked through the first temperature rise parameter, the food ingredients can be colored better. The second mode is a stable mode; when the food ingredients are cooked through the second temperature rise parameter, it can prevent the food ingredients from being burnt, and allow the food ingredients to be cooked stably and thoroughly.

Optionally, the first temperature rise parameter includes a heating temperature and a heating duration. The second temperature rise parameter includes a heating temperature and a heating duration, and a first heating curve formed by the first temperature rise parameter is different from a second heating curve formed by the second temperature rise parameter due to different heating temperatures and heating durations.

Based on some embodiments of the present application, optionally, the first temperature rise parameter includes a first target temperature value; in the case that the heating mode is the first mode, the step of controlling the heating part to operate with the first temperature rise parameter includes: acquiring the first target temperature value; determining the first temperature value and the second temperature value based on the first target temperature value; controlling the temperature value of the cooking cavity to fluctuate back and forth between the first temperature value and the second temperature value; and the second temperature value is greater than the first target temperature value, and the first target temperature value is greater than the first temperature value.

In the embodiment, the first temperature rise parameter includes the first target temperature value, and the step of controlling the heating part to operate with the first temperature rise parameter includes: acquiring the first target temperature value, determining the first temperature value and the second temperature value based on the first target temperature value, and controlling the heating part to supply heat to the cooking cavity, and the temperature value inside the cooking cavity fluctuates back and forth between the first temperature value and the second temperature value, then the curve formed by the temperature value inside the cooking cavity and the heating duration is a temperature curve with a peak and a valley, and then the food ingredients can be cooked through the back and forth fluctuating temperature, and this heating method is more conducive to the coloring of the food ingredients, and further achieves a better color of the cooked food and enhances the cooking effect.

It is understandable that the second temperature value is greater than the first target temperature value, and the first target temperature value is greater than the first temperature value, that is, the second temperature value is greater than the first target temperature value, and the second temperature value is less than the first target temperature value, and the temperature value inside the cooking cavity can fluctuate back and forth between the second temperature value which is greater than the first target temperature value and the first temperature value which is less than the first target temperature value, and this can not only cook the food ingredients thoroughly, but further achieve the coloring of the food ingredients.

In a specific application, the first target temperature value can be input by a user or determined through the recognition of food ingredient information. The food ingredient information includes the type of the food ingredient and the weight of the food ingredient, and the cooking temperature corresponding to different types and weights of the food ingredients can be stored in advance in the cooking appliance to enhance the automation level of the cooking appliance for the food ingredients.

It should be noted that the first target temperature value can be set or input based on different food ingredients. The first temperature value and the second temperature value can further be determined based on a set fluctuation range. Optionally, the temperature thresholds of the first temperature value and the second temperature value which fluctuate relative to the first target temperature value can be the same or different.

Based on some embodiments of the present application, optionally, the step of controlling the temperature value of a cooking cavity to fluctuate back and forth between the first temperature value and the second temperature value includes: in the case that the temperature value of the cooking cavity is less than or equal to the first temperature value, controlling the heating part to increase its power; in the case that the temperature value of the cooking cavity is greater than or equal to the second temperature value, controlling the heating part to reduce its power or turn it off.

In the embodiment, the step of controlling the temperature value of the cooking cavity to fluctuate back and forth between the first temperature value and the second temperature value includes: in the case that the temperature value of the cooking cavity is less than or equal to the first temperature value, increasing the power of the heating part, and the temperature value inside the cooking cavity gradually increases until it reaches the second temperature value; in the case that the temperature value of the cooking cavity is greater than or equal to the second temperature value, reducing the power of the heating part, and the temperature value inside the cooking cavity gradually reduces until it reaches the first temperature value, and fluctuates back and forth in this way; and in the case that the temperature value inside the cooking cavity is greater than or equal to the second temperature value, the heating part can be directly turned off to quickly lower the temperature value inside the cooking cavity, and thereby, the coloring effect of the food ingredients is improved.

Optionally, in the case that the temperature value inside the cooking cavity is less than or equal to the first temperature value, the heating part can further be operated at full power.

Based on some embodiments of the present application, optionally, the first temperature value is equal to the difference between the first target temperature value and a temperature threshold, and the second temperature value is equal to the sum of the first target temperature value and the temperature threshold.

In the embodiment, the first temperature value is equal to the difference between the first target temperature value and the temperature threshold, and the second temperature value is equal to the sum of the first target temperature value and the temperature threshold; furthermore, the first temperature value and the second temperature value can be determined based on the first target temperature value and the temperature threshold, to control the heating part to supply heat to the cooking cavity under the first mode, and the temperature value inside the cooking cavity fluctuates between the first temperature value and the second temperature value.

Based on some embodiments of the present application, optionally, the temperature threshold is greater than or equal to 3℃ and less than or equal to 15℃.

In the embodiment, the temperature threshold is greater than or equal to 3℃ and less than or equal to 15℃, and the temperature value inside the cooking cavity fluctuates in a large range, and then the coloring effect under the first mode is improved.

In a specific application, the temperature threshold is equal to any value among 3℃, 4℃, 5℃, 6℃, 7℃, 8℃, 9℃, 10℃, 11℃, 12℃, 13℃, 14℃, and 15℃.

Based on some embodiments of the present application, optionally, the first mode includes a temperature rise stage and a constant temperature stage, and the step of controlling the temperature value of the cooking cavity to fluctuate back and forth between the first temperature value and the second temperature value includes: in the constant temperature stage, controlling the temperature value of the cooking cavity to fluctuate back and forth between the first temperature value and the second temperature value.

In the embodiment, the first mode includes a temperature rise stage and a constant temperature stage, and after the heating part is turned on, the temperature value inside the cooking cavity gradually increases, this causes the temperature rise curve inside the cooking cavity to enter the constant temperature stage from the temperature rise stage. In the constant temperature stage, controlling the temperature value of the cooking cavity to fluctuate between the first temperature value and the second temperature value can not only achieve rapid cooking of the food ingredients, but further ensure the coloring effect of the food ingredients.

It is understandable that during the heating stage, the temperature value inside the cooking cavity gradually increases from the original temperature to the first target temperature value. In the constant temperature stage, the temperature value inside the cooking cavity has entered the range between the first temperature value and the second temperature value.

Based on some embodiments of the present application, optionally, the second temperature rise parameter includes a second target temperature value. Under the second mode, the step of controlling the heating part to operate with the second temperature rise parameter includes: acquiring the second target temperature value; controlling the temperature value of the cooking cavity to increase to the second target temperature value.

In the embodiment, the second temperature rise parameter includes the second target temperature value. Under the second mode, the step of controlling the heating part to operate with the second temperature rise parameter specifically includes: acquiring the second target temperature value; controlling the heating part to operate, and the temperature value inside the cooking cavity increases to the second target temperature value, thereby achieving supplying heat stably to the food ingredients inside the cooking cavity.

In a specific application, the temperature value of the cooking cavity is controlled to rise to the second target temperature value through an incremental PID (Proportional Integration Differentiation) method.

It should be noted that the incremental PID method is a basic form of a digital PID control algorithm, and is a control algorithm that conducts PID control on the increment of the control quantity (the difference between a current control quantity and a previous control quantity).

For example, in the case that the temperature value of the cooking cavity is less than or equal to the difference between the second target temperature value and the preset value, the heating part is controlled to increase its power or operate at full power to raise the temperature inside the cooking cavity. In the case that the temperature value inside the cooking cavity is greater than or equal to the sum of the second target temperature value and the preset value, the heating part is controlled to decrease its power or turn it off to lower the temperature inside the cooking cavity, and the temperature value inside the cooking cavity is maintained near the second target temperature value. It is understandable that the temperature threshold under the first mode is greater than the preset value under the second mode. It should be noted that under the first mode, the temperature threshold is set to make the temperature value inside the cooking cavity fluctuate up and down, and the temperature rise curve is wave shaped. Under the second mode, the preset value is set to keep the temperature value inside the cooking cavity near the second target temperature value, that is, under the second mode, the preset value is set to keep the temperature value inside the cooking cavity stable, instead of fluctuating.

Optionally, the preset value is greater than or equal to 0℃ and less than 3℃.

In a specific application, under the second mode, the temperature rise curve of the temperature value inside the cooking cavity and the heating duration includes the temperature rise stage and the constant temperature stage. In the constant temperature stage, the temperature value inside the cooking cavity is controlled to maintain near the second target temperature value. Specifically, under the second mode, the temperature rise curve in the cooking cavity is in a linear shape in the constant temperature stage.

Based on some embodiments of the present application, optionally, the number of the heating parts is at least two, and the cooking appliance further includes a cavity partition plate, and the cavity partition plate is detachably connected to the cooking cavity. In the case that the cavity partition plate is arranged in the cooking cavity, it divides the cooking cavity into at least two cavity bodies. The cooking appliance enters an independent temperature control mode, at least two heating parts supply heat to the at least two cavity bodies respectively, and the embodiment further includes: acquiring the temperature control mode of the cooking appliance; in the case that the temperature control mode is the independent temperature control mode, receiving operation inputs corresponding to the at least two cavity bodies respectively; in response to the operation inputs corresponding to the at least two cavity bodies, acquiring the temperature values of the at least two cavity bodies and controlling the at least two cavity bodies to enter heating modes corresponding to the operation inputs.

In the embodiment, the number of the heating parts is at least two, and the cooking appliance further includes the cavity partition plate, and the cavity partition plate is detachably connected to the cooking cavity. In the case that the cavity partition plate is arranged in the cooking cavity, it divides the cooking cavity into at least two cavity bodies. The cooking appliance enters the independent temperature control mode, the at least two heating parts achieve the heating of the at least two cavity bodies respectively, and furthermore, cooking different food ingredients is achieved through the at least two cavity bodies, and then the cooking efficiency is improved; in the case that the cavity partition plate is separated from the cooking cavity, the volume of the cooking cavity is relatively large, and this enables the cooking of food ingredients with a relatively large volume; at the same time, at least two heating parts can be configured to cook one type of food ingredient simultaneously, and this improves the cooking efficiency. The control method for a cooking appliance further includes: acquiring the temperature control mode of the cooking appliance; in the case that the temperature control mode of the cooking appliance is independent temperature control, it means that the cavity partition plate has been inserted into the cooking cavity, the cooking cavity is divided into at least two cavity bodies, and in this situation, receiving operation inputs corresponding to the at least two cavity bodies respectively; after responding to the operation inputs corresponding to the at least two cavity bodies, acquiring the temperature values of the at least two cavity bodies respectively, and allowing the at least two cavity bodies to enter the corresponding heating modes respectively, and the at least two cavity bodies can realize the heating mode under the first mode and the second mode respectively, that is, under the mode of independent temperature control of the cooking appliance, different heating modes can be realized through the at least two cavity bodies, for example, one cavity body can realize the heating of the first mode, and the food ingredients can be better colored, and the other cavity body can realize the heating of the second mode, and the food ingredients can be cooked stably and thoroughly.

Specifically, when the cavity partition plate is separated from the cooking cavity, the heating mode corresponding to the cooking cavity can be either the first mode or the second mode.

Based on some embodiments of the present application, optionally, the cooking appliance further includes a switch, and the switch is provided inside the cooking cavity. In the case that the cavity partition plate is provided inside the cooking cavity, the cavity partition plate can trigger the switch; the step of acquiring the temperature control mode of the cooking appliance includes: acquiring the trigger information of the switch; in the case that the switch is triggered, determining that the cooking appliance enters the independent temperature control mode.

In the embodiment, the cooking appliance further includes the switch, and the switch is provided inside the cooking cavity. In the case that the cavity partition plate is provided inside the cooking cavity, the cavity partition plate can trigger the switch, and then the cooking appliance enters the independent temperature control mode. Specifically, the trigger information of the switch is obtained, upon receiving that the switch has been triggered, it is determined that the cooking appliance enters the independent temperature control mode; under the independent temperature control mode, the control of the heating parts corresponding to the at least two cavity bodies can be realized respectively, thereby causing the heating parts corresponding to the at least two cavities to realize either the first mode or the second mode.

Optionally, the switch includes a micro switch.

In a specific application, the present application can achieve different cooking effects by setting the temperature rise curve that a user wants to achieve, which is more suitable for kitchen experts such as cooking masters. The coloring mode features temperature peaks and valleys that can fluctuate around ±8℃, and this allows a user to cook special foods based on this characteristic. In addition, a user can set the temperature control curve required for each cavity based on the divided cavities.

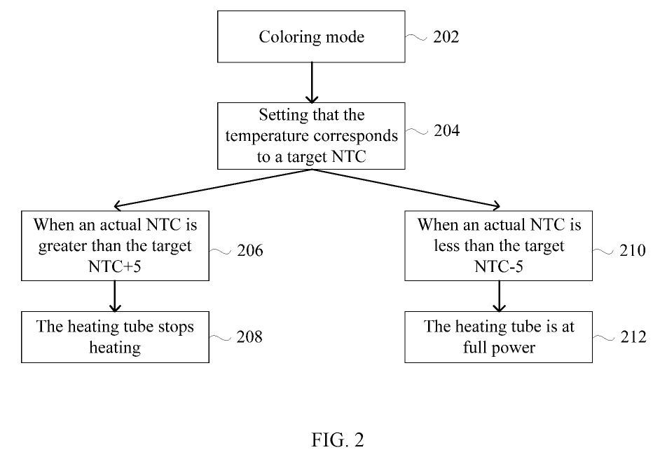

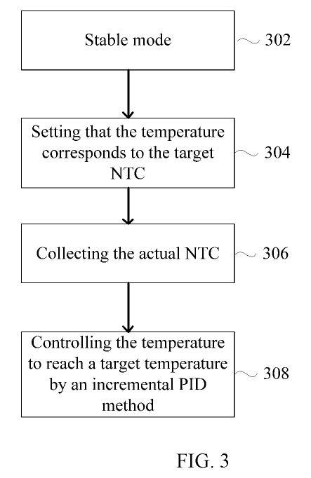

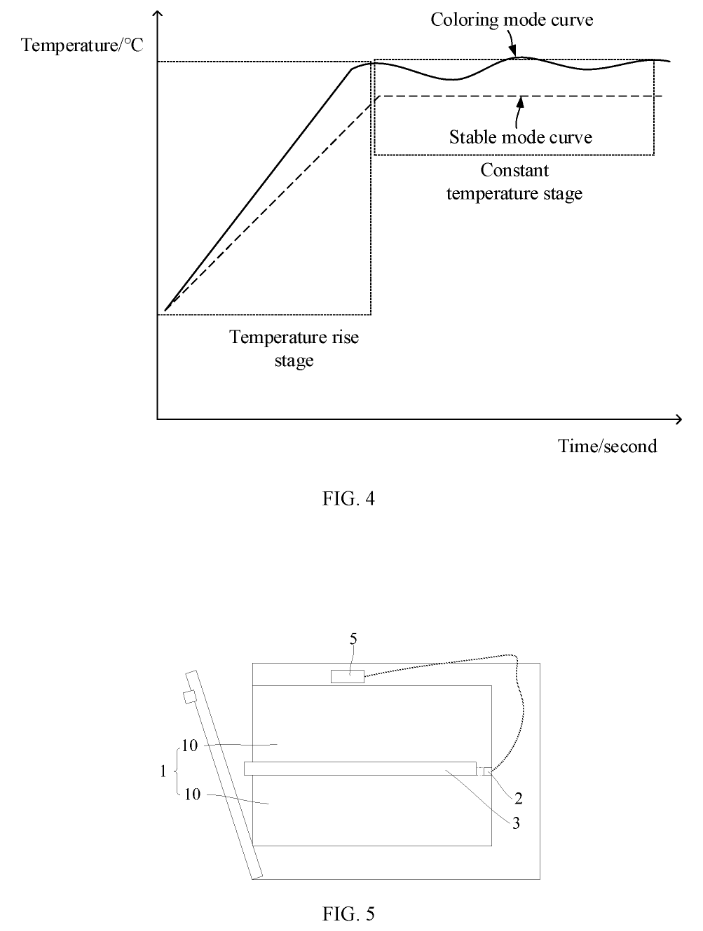

FIG. 4 is a diagram illustrating the temperature control curves of two temperature control modes. The temperature rise curve is divided into two stages, i.e., the temperature rise stage and the constant temperature stage. The constant temperature stage is divided into two modes: the coloring mode (for example, the first mode) and the stable mode (for example, the second mode). The specific control method is shown in FIGS. 2 and 3.

FIG. 2 is a flow chart of a control method for a cooking appliance under the first mode.

Step 202: a coloring mode;

Step 204: setting that the temperature corresponds to a target NTC;

Step 206: when an actual NTC is greater than the target NTC+5;

Step 208: the heating tube stops heating;

Step 210: when an actual NTC is less than the target NTC-5;

Step 212: the heating tube is at full power.

In the embodiment, setting a fluctuation range of 5°C causes the coloring of the ingredient to be better under the first mode. And NTC (Negative Temperature Coefficient) refers to a negative temperature coefficient. Specifically, the actual NTC can be understood as an actual temperature value, and the target NTC can be understood as the target temperature value.

FIG. 3 is a flow chart of a control method for a cooking appliance under the second mode.

Step 302: a stable mode;

Step 304: setting that the temperature corresponds to the target NTC;

Step 306: collecting the actual NTC;

Step 308: controlling the temperature to reach a target temperature by an incremental PID method.

In the embodiment, through the incremental PID method, the food ingredients can be cooked stably and thoroughly under the second mode.

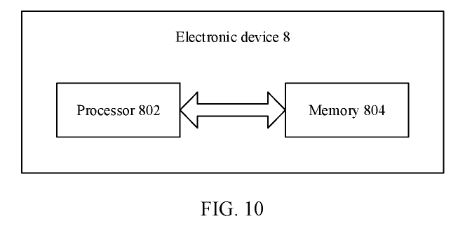

As shown in FIG. 9, an interactive logic diagram of the cooking appliance is presented. Specifically, after entering an independent mode, heating modes can be set for an upper cavity and a lower cavity respectively, and the coloring mode or the constant temperature mode can be set for the upper cavity, and the coloring mode or the constant temperature mode can further be set for the lower cavity.

Based on the present application, a user can set a target temperature control curve to achieve a desired temperature control effect, and this can be applied to various food ingredients, and achieve the desired cooking effect.

Embodiment 1: the user wants to use the upper cavity to grill beef and use the lower cavity to grill sweet potatoes; the user sets a coloring mode for the upper cavity and a stable mode to the lower cavity for coloring; after preheating, grilling is conducted, and the coloring effect of the beef is very good after the grilling is completed, with crispy exterior and tender interior.

Embodiment 2: when there is no division of an upper cavity and a lower cavity, only one temperature is set for the cavity, the user uses it to grill fruits and vegetables, as well as eggplants, and the user sets the temperature to be 200℃, with a target time of 20 minutes, the temperature control mode is set to be the stable mode; to prevent the eggplants from being burnt by high temperature peaks, the constant temperature mode is selected, and the cooking begins.

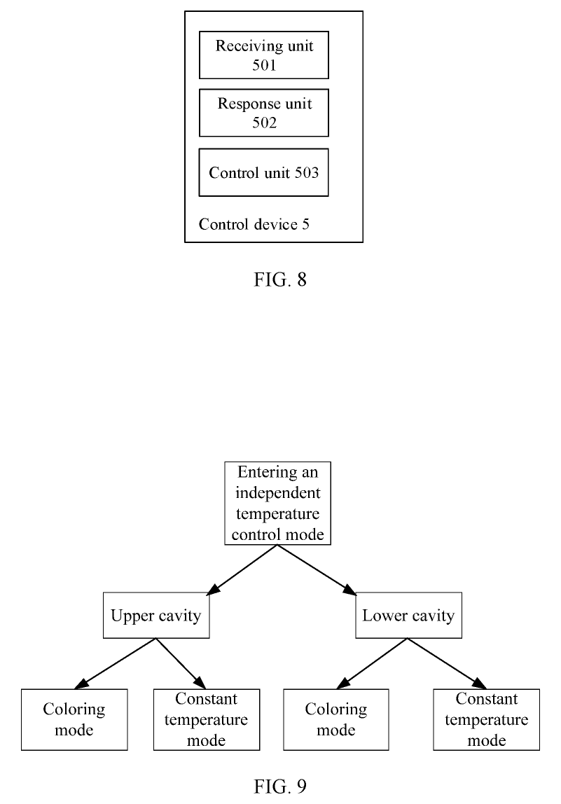

As shown in FIG. 8, based on an embodiment of the present application, a control device 5 of a cooking appliance is further provided, and the cooking appliance includes a cooking cavity and a heating part, the heating part is configured to supply heat to the cooking cavity, and the control device 5 of a cooking appliance includes: a receiving unit 501, configured for receiving an operation input for the cooking appliance; a response unit 502, configured for responding to the operation inputs; a control unit 503 configured for acquiring the temperature value of the cooking cavity and controlling the cooking appliance to enter a heating mode corresponding to the operation input; and the heating mode includes a first mode and a second mode; in the case that the heating mode is the first mode, the heating part is controlled to operate with a first temperature rise parameter; under the second mode, the heating part is controlled to operate with a second temperature rise parameter, and the first temperature rise parameter is different from the second temperature rise parameter.

The control device 5 of a cooking appliance provided by the present application includes the receiving unit 501, the response unit 502 and the control unit 503; the receiving unit 501 is configured for receiving an operation input for the cooking appliance; the response unit 502 responds to the operation input; the control unit 503 is configured for acquiring the temperature value of the cooking cavity and controlling the cooking appliance to enter the heating mode corresponding to the operation input. Specifically, the heating mode includes the first mode and the second mode; in the case that the heating mode is the first mode, the control unit 503 controls the heating part to operate with the first temperature rise parameter; in the case that the heating mode is the second mode, the control unit 503 controls the heating part to operate with the second temperature rise parameter, that is, the cooking appliance has at least two heating modes, and the first temperature rise parameter under the first mode is different from the second temperature rise parameter under the second mode, and the cooking appliance can cook different food ingredients through two different heating modes, and thus different food ingredients can be cooked through different temperature rise parameters, and this improves the cooking effects of different food ingredients, and further enables the control method for a cooking appliance provided in the present application to adapt to the cooking of various food ingredients, as a result, different food ingredients have different temperature rise curves, and then, users can choose the heating modes suitable for the food ingredients when cooking to achieve desired cooking effects.

In a specific application, the first mode is a coloring mode, that is, when the food ingredients are cooked through the first temperature rise parameter, the food ingredients can be colored better. The second mode is a stable mode; when the food ingredients are cooked through the second temperature rise parameter, it can prevent the food ingredients from being burnt, and allow the food ingredients to be cooked stably and thoroughly.

Optionally, the first temperature rise parameter includes a heating temperature and a heating duration. The second temperature rise parameter includes a heating temperature and a heating duration, and a first heating curve formed by the first temperature rise parameter is different from a second heating curve formed by the second temperature rise parameter due to different heating temperatures and heating durations.

Based on some embodiments of the present application, optionally, the first temperature rise parameter includes a first target temperature value; in the case that the heating mode is the first mode, the step that the control unit 503 controls the heating part to operate with the first temperature rise parameter includes: acquiring the first target temperature value; determining the first temperature value and the second temperature value based on the first target temperature value; controlling the temperature value of the cooking cavity to fluctuate back and forth between the first temperature value and the second temperature value; and the second temperature value is greater than the first target temperature value, and the first target temperature value is greater than the first temperature value.

In the embodiment, the first temperature rise parameter includes the first target temperature value, and the step of controlling the heating part to operate with the first temperature rise parameter includes: acquiring the first target temperature value, determining the first temperature value and the second temperature value based on the first target temperature value, and controlling the heating part to supply heat to the cooking cavity, and the temperature value inside the cooking cavity fluctuates back and forth between the first temperature value and the second temperature value, then the curve formed by the temperature value inside the cooking cavity and the heating duration is a temperature curve with a peak and a valley, and then the food ingredients can be cooked through the back and forth fluctuating temperature, and this heating method is more conducive to the coloring of the food ingredients, and further achieves a better color of the cooked food and enhances the cooking effect.

It is understandable that the second temperature value is greater than the first target temperature value, and the first target temperature value is greater than the first temperature value, that is, the second temperature value is greater than the first target temperature value, and the second temperature value is less than the first target temperature value, and the temperature value inside the cooking cavity can fluctuate back and forth between the second temperature value which is greater than the first target temperature value and the first temperature value which is less than the first target temperature value, and this can not only cook the food ingredients thoroughly, but further achieve the coloring of the food ingredients.

In a specific application, the first target temperature value can be input by a user or determined through the recognition of food ingredient information. And the food ingredient information includes the type of the food ingredient and the weight of the food ingredient, and the cooking temperature corresponding to different types and weights of the food ingredients can be stored in advance in the cooking appliance to enhance the automation level of the cooking appliance for the food ingredients.

It should be noted that the first target temperature value can be set or input based on different food ingredients. The first temperature value and the second temperature value can further be determined based on a set fluctuation range. Optionally, the temperature thresholds of the first temperature value and the second temperature value which fluctuate relative to the first target temperature value can be the same or different.

Based on some embodiments of the present application, optionally, the step that the control unit 503 controls the temperature value of a cooking cavity to fluctuate back and forth between the first temperature value and the second temperature value includes: in the case that the temperature value of the cooking cavity is less than or equal to the first temperature value, controlling the heating part to increase its power; in the case that the temperature value of the cooking cavity is greater than or equal to the second temperature value, controlling the heating part to reduce its power or turn it off.

In the embodiment, the step of controlling the temperature value of a cooking cavity to fluctuate back and forth between the first temperature value and the second temperature value includes: in the case that the temperature value of the cooking cavity is less than or equal to the first temperature value, increasing the power of the heating part, and the temperature value inside the cooking cavity gradually increases until it reaches the second temperature value; in the case that the temperature value of the cooking cavity is greater than or equal to the second temperature value, reducing the power of the heating part, and the temperature value inside the cooking cavity gradually reduces until it reaches the first temperature value, and fluctuates back and forth in this way; and in the case that the temperature value inside the cooking cavity is greater than or equal to the second temperature value, the heating part can be directly turned off to quickly lower the temperature value inside the cooking cavity, and the coloring effect of the food ingredients is improved.

Optionally, in the case that the temperature value inside the cooking cavity is less than or equal to the first temperature value, the heating part can further be operated at full power.

Based on some embodiments of the present application, optionally, the first temperature value is equal to the difference between the first target temperature value and a temperature threshold, and the second temperature value is equal to the sum of the first target temperature value and the temperature threshold.

In the embodiment, the first temperature value is equal to the difference between the first target temperature value and the temperature threshold, and the second temperature value is equal to the sum of the first target temperature value and the temperature threshold; furthermore, the first temperature value and the second temperature value can be determined based on the first target temperature value and the temperature threshold, to control the heating part to supply heat to the cooking cavity under the first mode, and the temperature value inside the cooking cavity fluctuates between the first temperature value and the second temperature value.

Based on some embodiments of the present application, optionally, the temperature threshold is greater than or equal to 3℃ and less than or equal to 15℃.

In the embodiment, the temperature threshold is greater than or equal to 3℃ and less than or equal to 15℃, and the temperature value inside the cooking cavity fluctuates in a large range, and then the coloring effect under the first mode is improved.

In a specific application, the temperature threshold is equal to any value among 3℃, 4℃, 5℃, 6℃, 7℃, 8℃, 9℃, 10℃, 11℃, 12℃, 13℃, 14℃, and 15℃.

Based on some embodiments of the present application, optionally, the first mode includes a temperature rise stage and a constant temperature stage, and the step that the control unit 503 controls the temperature value of the cooking cavity to fluctuate back and forth between the first temperature value and the second temperature value includes: in the constant temperature stage, controlling the temperature value of the cooking cavity to fluctuate back and forth between the first temperature value and the second temperature value.

In the embodiment, the first mode includes a temperature rise stage and a constant temperature stage, and after the heating part is turned on, the temperature value inside the cooking cavity gradually increases, this causes the temperature rise curve inside the cooking cavity to enter the constant temperature stage from the temperature rise stage. In the constant temperature stage, controlling the temperature value of the cooking cavity to fluctuate between the first temperature value and the second temperature value can not only achieve rapid cooking of the food ingredients, but further ensure the coloring effect of the food ingredients.

It is understandable that during the heating stage, the temperature value inside the cooking cavity gradually increases from the original temperature to the first target temperature value. In the constant temperature stage, the temperature value inside the cooking cavity has entered the range between the first temperature value and the second temperature value.

Based on some embodiments of the present application, optionally, the second temperature rise parameter includes a second target temperature value. Under the second mode, the step that the control unit 503 controls the heating part to operate with the second temperature rise parameter includes: acquiring the second target temperature value; controlling the temperature value of the cooking cavity to increase to the second target temperature value.

As In the embodiment, the second temperature rise parameter includes the second target temperature value. Under the second mode, the step of controlling the heating part to operate with the second temperature rise parameter specifically includes: acquiring the second target temperature value; controlling the heating part to operate, and the temperature value inside the cooking cavity increases to the second target temperature value, thereby achieving supplying heat stably to the food ingredients inside the cooking cavity.

In a specific application, the temperature value of the cooking cavity is controlled to rise to the second target temperature value through an incremental PID method.

It should be noted that the incremental PID method is a basic form of a digital PID control algorithm, and is a control algorithm that conducts PID control to the increment of the control quantity (the difference between a current control quantity and a previous control quantity).

For example, in the case that the temperature value of the cooking cavity is less than or equal to the difference between the second target temperature value and the preset value, the heating part is controlled to increase its power or operate at full power to raise the temperature inside the cooking cavity. In the case that the temperature value inside the cooking cavity is greater than or equal to the sum of the second target temperature value and the preset value, the heating part is controlled to decrease its power or turn it off to lower the temperature inside the cooking cavity, and the temperature value inside the cooking cavity is maintained near the second target temperature value. It is understandable that the temperature threshold under the first mode is greater than the preset value under the second mode. It should be noted that under the first mode, the temperature threshold is set to make the temperature value inside the cooking cavity fluctuate up and down, and the temperature rise curve is wave shaped. Under the second mode, the preset value is set to keep the temperature value inside the cooking cavity near the second target temperature value, that is, under the second mode, the preset value is set to keep the temperature value inside the cooking cavity stable, instead of fluctuating.

Optionally, the preset value is greater than or equal to 0℃ and less than 3℃.

In a specific application, under the second mode, the temperature rise curve of the temperature value inside the cooking cavity and the heating duration includes the temperature rise stage and the constant temperature stage. In the constant temperature stage, the temperature value inside the cooking cavity is controlled to be maintained near the second target temperature value. Specifically, under the second mode, the temperature rise curve in the cooking cavity is in a linear shape in the constant temperature stage.

Based on some embodiments of the present application, optionally, the number of the heating parts is at least two, and the cooking appliance further includes a cavity partition plate, and the cavity partition plate is detachably connected to the cooking cavity. In the case that the cavity partition plate is arranged in the cooking cavity, it divides the cooking cavity into at least two cavity bodies. The cooking appliance enters an independent temperature control mode, at least two heating parts supply heat to the at least two cavity bodies respectively, and the control unit 503 is further configured for: acquiring the temperature control mode of the cooking appliance; in the case that the temperature control mode is the independent temperature control mode, the receiving unit 501 is further configured for receiving operation inputs corresponding to the at least two cavity bodies respectively; the response unit 502 is further configured for responding to the operation inputs corresponding to the at least two cavity bodies, and the control unit 503 is further configured for acquiring the temperature values of the at least two cavity bodies and controlling the at least two cavity bodies to enter heating modes corresponding to the operation inputs.

In the embodiment, the number of the heating parts is at least two, and the cooking appliance further includes the cavity partition plate, and the cavity partition plate is detachably connected to the cooking cavity. In the case that the cavity partition plate is arranged in the cooking cavity, it divides the cooking cavity into at least two cavity bodies. The cooking appliance enters the independent temperature control mode, the at least two heating parts achieve the heating of the at least two cavity bodies respectively, and furthermore, cooking different food ingredients is achieved through the at least two cavity bodies, and then the cooking efficiency is improved; in the case that the cavity partition plate is separated from the cooking cavity, the volume of the cooking cavity is relatively large, and this enables the cooking of food ingredients with a relatively large volume; at the same time, at least two heating parts can be configured to cook one type of food ingredient simultaneously, and this improves the cooking efficiency. The control method for a cooking appliance further includes: acquiring the temperature control mode of the cooking appliance; in the case that the temperature control mode of the cooking appliance is independent temperature control, it means that the cavity partition plate has been inserted into the cooking cavity, the cooking cavity is divided into at least two cavity bodies, and in this situation, receiving operation inputs corresponding to the at least two cavity bodies respectively; after responding to the operation inputs corresponding to the at least two cavity bodies, acquiring the temperature values of the at least two cavity bodies respectively, and allowing the at least two cavity bodies to enter the corresponding heating modes respectively, and the at least two cavity bodies can realize the heating mode under the first mode and the second mode respectively, that is, under the mode of independent temperature control of the cooking appliance, different heating modes can be realized through the at least two cavity bodies, for example, one cavity body can realize the heating of the first mode, and the food ingredients can be better colored, and the other cavity body can realize the heating of the second mode, and the food ingredients can be cooked stably and thoroughly.

Specifically, when the cavity partition plate is separated from the cooking cavity, the heating mode corresponding to the cooking cavity can be either the first mode or the second mode.

Based on some embodiments of the present application, optionally, the cooking appliance further includes a switch, and the switch is provided inside the cooking cavity. In the case that the cavity partition plate is provided inside the cooking cavity, the cavity partition plate can trigger the switch; the step that the control unit 503 acquires the temperature control mode of the cooking appliance includes: acquiring the trigger information of the switch; in the case that the switch is triggered, determining that the cooking appliance enters the independent temperature control mode.

In the embodiment, the cooking appliance further includes the switch, and the switch is provided inside the cooking cavity. In the case that the cavity partition plate is provided inside the cooking cavity, the cavity partition plate can trigger the switch, and then the cooking appliance enters the independent temperature control mode. Specifically, the trigger information of the switch is obtained, upon receiving that the switch has been triggered, it is determined that the cooking appliance enters the independent temperature control mode; under the independent temperature control mode, the control of the heating parts corresponding to the at least two cavity bodies can be realized respectively, thereby causing the heating parts corresponding to the at least two cavities to realize either the first mode or the second mode.

In a specific application, the switch includes a micro switch.

As shown in FIGS. 5 and 7, based on an embodiment of the present application, a cooking appliance 7 is further provided, and it includes: a cooking cavity 1; a heating part 4, and the heating part 4 is configured to supply heat to the cooking cavity 1; and the control device 5 of a cooking appliance 7 provided in any of the second aspect.

The cooking appliance 7 provided by the present application includes the cooking cavity 1 and the heating part 4 configured to supply heat to the cooking cavity 1. The control device 5 receives the operation input for the cooking appliance 7, and in response to the operation input, acquires the temperature value of the cooking cavity 1 and controls the cooking appliance 7 to enter the heating mode corresponding to the operation input. Specifically, the heating mode includes the first mode and the second mode. In the case that the heating mode is the first mode, the heating part 4 is controlled to operate with the first temperature rise parameter. In the case that the heating mode is the second mode, the heating part 4 is controlled to operate with the second temperature rise parameter, that is, the cooking appliance 7 has at least two heating modes, and the first temperature rise parameter under the first mode is different from the second temperature rise parameter under the second mode, and the cooking appliance 7 can cook different food ingredients through two different heating modes, and thus different food ingredients can be cooked through different temperature rise parameters, and this improves the cooking effects of different food ingredients, and further enables the control method for a cooking appliance 7 provided in the present application to adapt to the cooking of various food ingredients, as a result, different food ingredients have different temperature rise curves, and then, users can choose the heating modes suitable for the food ingredients when cooking to achieve desired cooking effects.

In a specific application, the first mode is a coloring mode, that is, when the food ingredients are cooked through the first temperature rise parameter, the food ingredients can be colored better. The second mode is a stable mode; when the food ingredients are cooked through the second temperature rise parameter, it can prevent the food ingredients from being burnt, and allow the food ingredients to be cooked stably and thoroughly.

Optionally, the first temperature rise parameter includes a heating temperature and a heating duration. The second temperature rise parameter includes a heating temperature and a heating duration, and a first heating curve formed by the first temperature rise parameter is different from a second heating curve formed by the second temperature rise parameter due to different heating temperatures and heating durations.

As shown in FIGS. 5 and 7, based on some embodiments of the present application, optionally, the number of the heating parts 4 is at least two, and the cooking appliance 7 further includes a cavity partition plate 3, and the cavity partition plate 3 is detachably connected to the cooking cavity 1. In the case that the cavity partition plate 3 is arranged in the cooking cavity 1, it divides the cooking cavity 1 into at least two cavity bodies 10. The cooking appliance 7 enters an independent temperature control mode, and at least two heating parts 4 supply heat to the at least two cavity bodies 10 respectively.

In the embodiment, the number of the heating parts 4 is at least two, and the cooking appliance 7 further includes the cavity partition plate 3, and the cavity partition plate 3 is detachably connected to the cooking cavity 1. In the case that the cavity partition plate 3 is arranged in the cooking cavity 1, it divides the cooking cavity 1 into at least two cavity bodies 10. The cooking appliance 7 enters the independent temperature control mode, the at least two heating parts 4 achieve supplying heat to the at least two cavity bodies 10 respectively, and furthermore, cooking different food ingredients is achieved through the at least two cavity bodies 10, and then the cooking efficiency is improved; in the case that the cavity partition plate 3 is separated from the cooking cavity 1, the volume of the cooking cavity 1 is relatively large, and this enables the cooking of food ingredients with a relatively large volume; at the same time, at least two heating parts 4 can be configured to cook one type of food ingredient simultaneously, and this improves the cooking efficiency.

Specifically, under the mode of independent temperature control of the cooking appliance 7, different heating modes can be realized through the at least two cavity bodies 10, for example, one cavity body 10 can realize the heating of the first mode, and the food ingredients can be better colored, and the other cavity body 10 can realize the heating of the second mode, and the food ingredients can be cooked stably and thoroughly.

As shown in FIG. 5, based on some embodiments of the present application, optionally, the cooking appliance 7 further includes a switch 2, and the switch 2 is provided inside the cooking cavity 1. In the case that the cavity partition plate 3 is provided inside the cooking cavity 1, the cavity partition plate 3 can trigger the switch 2.

In the embodiment, the cooking appliance 7 further includes the switch 2, and the switch 2 is provided inside the cooking cavity 1. In the case that the cavity partition plate 3 is provided inside the cooking cavity 1, the cavity partition plate 3 can trigger the switch 2, and then the cooking appliance 7 enters the independent temperature control mode.

Based on some embodiments of the present application, optionally, the cooking appliance 7 further includes: a baking tray 6, detachably provided inside the cooking cavity 1; and/or at least two cavity bodies 10 being distributed vertically.

In the embodiment, the at least two cavity bodies 10 are distributed vertically, and this reduces the occupation of the horizontal space of the kitchen by the cooking appliance 7 and facilitates the storage of the cooking appliance 7. The cooking appliance 7 further includes the baking tray 6, and the baking tray 6 can carry the food ingredients and further achieve the cooking of the food ingredients.

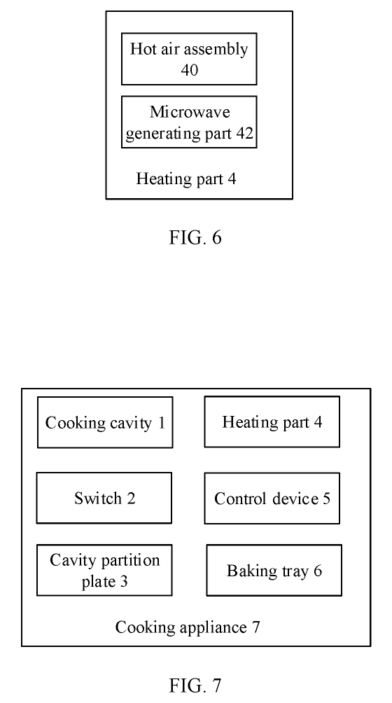

As shown in FIG. 6, based on some embodiments of the present application, optionally, the heating part 4 includes a hot air assembly 40, and the hot air assembly 40 is configured to deliver hot air into the cooking cavity 1.

In the embodiment, the heating part 4 includes the hot air assembly 40, and the hot air assembly 40 can deliver hot air into the cooking cavity 1, and this further achieves air frying of the food ingredients.

Specifically, the cooking appliance 7 includes at least two hot air assemblies 40, and in the case that the cavity partition plate 3 is arranged inside the cooking cavity 1, the at least two hot air assemblies 40 respectively deliver hot air to at least two cavity bodies 10.

Specifically, the hot air assembly 40 includes a fan and a heating tube, and the fan can transfer the heat of the heating tube to the cooking cavity 1.

As shown in FIG. 6, based on some embodiments of the present application, optionally, the heating part 4 includes a heating tube for radiating heat into the cooking cavity 1. That is, the heating part 4 in the present application can be a heating tube, and in the case that there are at least two heating tubes, the at least two heating parts 4 respectively radiate heat into the cooking cavity 1.

Based on some embodiments of the present application, optionally, the heating part 4 further includes a microwave generating part 42 for feeding microwaves into the cooking cavity 1.

In the embodiment, the heating part 4 further includes the microwave generating part 42 for feeding microwaves into the cooking cavity 1, and this further achieves microwave cooking of the food ingredients inside the cooking cavity 1.

It is understandable that the cooking appliance 7 provided in the present application has both the hot air cooking function and the microwave cooking function, and this enhances the cooking selectivity and cooking effect.

In a specific application, there are at least two microwave generating parts 42, and the at least two microwave generating parts 42 can correspond to at least two cavity bodies 10 and feed microwaves into the at least two cavity bodies 10 respectively.

Specifically, cooking appliance 7 includes an oven, an air fryer, an air fryer microwave all-in-one machine, a microwave oven, etc.

As shown in FIG. 10, based on an embodiment of the present application, an electronic device 8 is further provided, and it includes a processor 802 and a memory 804, and the memory 804 stores programs or instructions which can be executed on the processor 802, when the programs or instructions are executed by the processor 802, the steps of the control method for a cooking appliance provided in any of the above items are achieved. Therefore, the electronic device has all the beneficial effects of the control method for a cooking appliance, which will not be repeated here.

Based on an embodiment of the present application, a computer-readable storage medium is further provided, programs or instructions are stored on the computer-readable storage medium, when the programs or instructions are executed by the processor, the steps of the control method for a cooking appliance provided in any of the above items are implemented. Therefore, the computer-readable storage medium has all the beneficial effects of the control method for a cooking appliance, which will not be repeated here.

The methodologies described herein may be implemented by various means depending upon applications according to particular features and/or examples. For example, such methodologies may be implemented in hardware, firmware, and/or combinations thereof, along with software. In a hardware implementation, for example, a processor may be implemented within one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, electronic devices, other devices units designed to perform the functions described herein, and/or combinations thereof.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media, or electrical signals transmitted through a wire.

In the present application, the term of “multiple” refers to two or more than two, unless otherwise clearly defined. The terms “mount”, “connected to”, “connected to”, “fix” and the like should be understood in a broad sense, for example, the term “connected to” can be a fixed connection, a detachable connection, or an integral connection; the term “connected to” can be a direct connection, or an indirect connection through an intermediate medium. The specific meanings of the above terms in the present application can be understood based on the specific situations.

In the specification of the present application, the descriptions of the phrases “one embodiment”, “some embodiments” or “specific embodiments” and the like mean that the specific features, structures, materials or characteristics described in combination with the embodiment or example are included in at least one embodiment or example of the present application. In the specification of the present application, the illustrative expressions of the above terms may not necessarily refer to the same embodiments or examples. Moreover, the specific features, structures, materials, or characteristics described can be combined in any one or more embodiments or examples in a suitable manner.

Described above are only some embodiments of the present application and are not intended to limit the present application. The present application may have various modifications and variations. Any modifications, equivalent substitutions, improvements, etc. made within the spirit and principles of this application shall be included within the scope of protection of this application.

What is claimed is:

1. A control method for a cooking appliance, the cooking appliance comprising a cooking cavity and a heating part, and the heating part being configured for supplying heat to the cooking cavity, wherein, the control method comprises:
receiving an operation input for the cooking appliance;
in response to the operation input, acquiring a temperature value of the cooking cavity and controlling the cooking appliance to enter a heating mode corresponding to the operation input;
wherein the heating mode comprises a first mode and a second mode, and in the case that the heating mode is the first mode, the heating part is controlled to operate with a first temperature rise parameter; and under the second mode, the heating part is controlled to operate with a second temperature rise parameter, and the first temperature rise parameter is different from the second temperature rise parameter.

2. The control method for a cooking appliance according to claim 1, wherein, the first temperature rise parameter comprises a first target temperature value; in the case that the heating mode is the first mode, the step of controlling the heating part to operate with the first temperature rise parameter comprises:
acquiring the first target temperature value;
determining the first temperature value and the second temperature value based on the first target temperature value; and
controlling the temperature value of the cooking cavity to fluctuate back and forth between the first temperature value and the second temperature value;
wherein, the second temperature value is greater than the first target temperature value, and the first target temperature value is greater than the first temperature value.

3. The control method for a cooking appliance according to claim 2, wherein, the step of controlling the temperature value of the cooking cavity to fluctuate back and forth between the first temperature value and the second temperature value comprises:
in the case that the temperature value of the cooking cavity is less than or equal to the first temperature value, controlling the heating part to increase its power; and
in the case that the temperature value of the cooking cavity is greater than or equal to the second temperature value, controlling the heating part to reduce its power or turn it off.

4. The control method for a cooking appliance according to claim 3, wherein,
the first temperature value is equal to the difference between the first target temperature value and a temperature threshold, and the second temperature value is equal to the sum of the first target temperature value and the temperature threshold.

5. The control method for a cooking appliance according to claim 4, wherein, the temperature threshold is greater than or equal to 3℃ and less than or equal to 15℃.

6. The control method for a cooking appliance according to claim 2, wherein, the first mode comprises a temperature rise stage and a constant temperature stage, and the step of controlling the temperature value of the cooking cavity to fluctuate back and forth between the first temperature value and the second temperature value comprises:
in the constant temperature stage, controlling the temperature value of the cooking cavity to fluctuate back and forth between the first temperature value and the second temperature value.

7. The control method for a cooking appliance according to claim 1, wherein, the second temperature rise parameter comprises a second target temperature value, and under the second mode, the step of controlling the heating part to operate with the second temperature rise parameter comprises:
acquiring the second target temperature value; and
controlling the temperature value of the cooking cavity to increase to the second target temperature value.

8. The control method for a cooking appliance according to claim 1, wherein, the number of the heating parts is at least two, and the cooking appliance further comprises a cavity partition plate, and the cavity partition plate is detachably connected to the cooking cavity, and in the case that the cavity partition plate is arranged in the cooking cavity, it divides the cooking cavity into at least two cavity bodies, the cooking appliance enters an independent temperature control mode, at least two heating parts supply heat to the at least two cavity bodies respectively, and the control method for a cooking appliance further comprises:
acquiring the temperature control mode of the cooking appliance;
in the case that the temperature control mode is the independent temperature control mode:
receiving the operation inputs corresponding to the at least two cavity bodies respectively;
in response to the operation inputs corresponding to the at least two cavity bodies, acquiring the temperature values of the at least two cavity bodies and controlling the at least two cavity bodies to enter the heating modes corresponding to the operation inputs.

9. The control method for a cooking appliance according to claim 8, wherein, the cooking appliance further comprises a switch, and the switch is provided inside the cooking cavity, and in the case that the cavity partition plate is provided inside the cooking cavity, the cavity partition plate is configured to trigger the switch; the step of acquiring the temperature control mode of the cooking appliance comprises:
acquiring trigger information of the switch;
in the case that the switch is triggered, determining that the cooking appliance enters the independent temperature control mode.

10. A control device of a cooking appliance, the cooking appliance comprising a cooking cavity and a heating part, the heating part being configured to supply heat to the cooking cavity, wherein, the control device of a cooking appliance comprises:
a receiving unit, configured for receiving an operation input for the cooking appliance;
a response unit, configured for responding to the operation input;
a control unit, configured for acquiring a temperature value of the cooking cavity and controlling the cooking appliance to enter a heating mode corresponding to the operation input;
wherein, the heating mode comprises a first mode and a second mode, in the case that the heating mode is the first mode, the heating part is controlled to operate with a first temperature rise parameter; under the second mode, the heating part is controlled to operate with a second temperature rise parameter, and the first temperature rise parameter is different from the second temperature rise parameter.

11. A cooking appliance, comprising:
a cooking cavity;
a heating part, wherein the heating part is configured to supply heat to the cooking cavity; and
the control device of a cooking appliance according to claim 10.

12. The cooking appliance according to claim 11, wherein, the number of the heating parts is at least two, and the cooking appliance further comprises:
a cavity partition plate, wherein the cavity partition plate is detachably connected to the cooking cavity, and in the case that the cavity partition plate is arranged in the cooking cavity, it divides the cooking cavity into at least two cavity bodies, the cooking appliance enters an independent temperature control mode, and at least two heating parts supply heat to the at least two cavity bodies respectively.

13. The cooking appliance according to claim 12, further comprising:
a switch, provided inside the cooking cavity;
in the case that the cavity partition plate is provided inside the cooking cavity, the cavity partition plate is configured to trigger the switch.

14. The cooking appliance according to claim 13, further comprising:
a baking tray, detachably provided inside the cooking cavity; and/or
at least two cavity bodies being distributed vertically.

15. The cooking appliance according to claim 11, wherein the heating part comprises:
a hot air assembly, wherein the hot air assembly is configured to deliver hot air into the cooking cavity.

16. The cooking appliance according to claim 15, wherein, the heating part further comprises:
a microwave generating part for feeding microwaves into the cooking cavity.

17. An electronic device, comprising a processor and a memory, wherein the memory stores programs or instructions which are configured to be executed on the processor, when the programs or instructions are executed by the processor, the steps of the control method for a cooking appliance according to claim 1 are achieved.

18. A computer-readable storage medium, in which programs or instructions are stored, wherein, when the programs or instructions are executed by a processor, the steps of the control method for a cooking appliance according to claim 1 are implemented.
